(19) United States
(12) Patent Application Publication
(10) Pub. No.: US 2016/0243695 A1
(43) Pub. Date: Aug. 25, 2016

(54) PUSH BUTTON RELEASE MULTIPLE SOCKET HOLDER

(71) Applicant: WILLIAM LAWRENCE BILLUPS, JR., Glen Allen, VA (US)

(72) Inventor: WILLIAM LAWRENCE BILLUPS, JR., Glen Allen, VA (US)

(21) Appl. No.: 15/046,754

(22) Filed: Feb. 18, 2016

Related U.S. Application Data
(60) Provisional application No. 62/176,412, filed on Feb. 19, 2015.

(51) Int. Cl. B25H 3/00

(52) U.S. Cl. CPC B25H 3/003

(57) ABSTRACT

A socket holder with a built in locking mechanism that is user controlled and activated by a push button which controls internal locking mechanisms which allow this socket holder to securely store and transport sockets mounted to it. This push button release multiple socket holder can hold a multiple of sockets to its main socket holder body, releasing them only when desired by the user with the push of a push button that controls the internal mechanisms which release sockets from its socket holder main body. Only when the push button control is activated engaging internal locking mechanisms will the sockets being held onto it be released allowing sockets be mounted onto it to be secure in place. Sockets are allowed to come off or be put onto this lockable socket holder only when the main push button which controls the locking action of this socket holder. This socket holder is designed to organize and securely lock sockets onto its main holder body in a way that is dependable and easy to use.

### BACKGROUND OF THE INVENTION

The field of endeavor which is being discussed here relates to tools and equipment that use mechanical fasteners such as bolts, nuts, screws and in particular to the kind of tools that have “sockets” such as mechanics sockets in automobile repairs, aircraft and machinery. Even more particular to the actual “holders of these sockets.” The “socket holder” being very important as these various sized sockets in different sized sets come in a multiple of different sizes for various kinds of fasteners and in a multiple of different connecting drive size's that tools using these said sockets use make making the need for a durable and reliable holder with this new Locking Mechanism of Locking sockets onto their holder a feature and a necessity that has not been previously there and the lack of it not being there the cause of much frustration, confusion and time wasting in the past looking for these many different sockets while working on various jobs using sockets in the past.

With many different size sockets and different drive sizes not being kept in decent order with a secure and reliable way of doing this has been the reason for much confusion and wasted time. (example) ¼″ ⅜″ ½″ ¾″ 1″ and above drive sizes for various tools, and each size drive of a socket has many working size ends that go on each set. This is why it is very important to have a secure and durable way that is easy to use and reliable.

The background of the invention comes from the need of: NOT having a strong and reliable way to easily lock mount and dismount tool sockets to a socket holder in a strong, secure reliable and easy to use dependable way.

The previous way of carrying these tool sockets for many people was to just put them in a box or a bag, making these sockets very hard to access easily and quickly, and causing great frustration for many when looking for said sockets when they were needed on any particular job where a multiple of different size sockets were needed.

Also there have been a few unreliable and not very dependable devices that have been used that did not have a locking mechanism on them to keep these various sockets in their respective storage spaces when not being used for work or in transport while also not being very durable. For the most part it seemed the only time a set of sockets was in order and easy to find was when they first came in the box or in the shipping container from the manufacturer of these said sockets, and because previous socket holders could not Lock on Sockets to a multiple socket holder device in a secure and durable way use and transport of these socket holders was not practical for mobile use in and around the shop and to and from various job locations.

The invention being introduced here in this application, gives a strong reliable and effective way of Locking sockets onto a socket holder while organizing, storing and transporting these kinds of tool sockets to users of said sockets that has previously not been available to them, the user of such tool sockets to use to hold their tool sockets while doing various jobs with them and then transporting them to their next job site.

Using this Secure and Lockable socket holder device will maintain these sockets in their organized holding spaces on the socket holder dependably.

Keeping these sockets of different varying sizes in their respective holder spaces securely and dependably according to their ascending or descending size order will enable quick and easy access to them when they are needed for use, eliminating wasted time and frustration looking for them by keeping them stored in an orderly fashion on the easy to use, lockable “PUSH BUTTON RELEASE MULTIPLE SOCKET HOLDER” being introduced here.

### BRIEF SUMMARY OF THE INVENTION

The invention claimed here is a “PUSH BUTTON RELEASE MULTIPLE SOCKET HOLDER” which is designed to securely hold a multiple amount of various sized tool sockets to a socket holder with a user controlled locking mechanism.

The main feature of the socket holder being introduced here is its ability to hold sockets onto its main socket holder body with a user controlled Lockable internal mechanism.

This locking on and off of a multiple amount of various sized sockets to its main socket holder body, while keeping them in an organized way dependably, while also providing a quick and easy way of doing locking on and off of sockets with the push of a button is the reason for the introduction of this the herein named invention of a “PUSH BUTTON MULTIPLE SOCKET HOLDER”

With the simple push of this heretofore mentioned socket holders Main Push Button, multiples of sockets can be placed on or off of its main holder body quickly and easily as needed.

Sockets are to be released from this socket holders storage body only when the locking mechanism is engaged by the push of the PUSH BUTTON on the socket holder body by the user.

The locking mechanism that securely holds the sockets in their designated storage locations on this “PUSH BUTTON RELEASE MULTIPLE SOCKET HOLDER” is performed by a series of internal locking mechanisms which are controlled by the push of a PUSH BUTTON and solves the previously existing problems of loose and scattered sockets as identified and mentioned in the background of the invention.

Being strong in design and with its locking mechanism holding the mounted sockets onto its socket holder body in their designated drive and socket size storage spaces on the socket holder while also allowing for fast and easy mounting and retrieval of the many sockets being stored it by its locking PUSH BUTTON hold and release feature the “PUSH BUTTON RELEASE MULTIPLE SOCKET HOLDER” will be organized and ready for work when it is needed by the user of these tool sockets.

Being able to carry a multiple of various sized sockets that are mounted in a very organized and orderly fashion will allow for convenient and easy use at any job location where this the “PUSH BUTTON RELEASE MULTIPLE SOCKET HOLDER” is at with its complete and organized set of locked onto it, sockets will be in order and ready to be put to work with all of the sockets being held in their organized and locked on way to the main socket holders storage space order waiting to be used and put to work on this the “PUSH BUTTON RELEASE MULTIPLE SOCKET HOLDER”.

### BRIEF DESCRIPTION OF THE DRAWINGS

FIG. 1 Is an isometric view of the push button release multiple socket holder which has an internal socket holding locking control mechanism, which uses a push button to control the hold and release of sockets being held to its main socket holder body. Internal mechanisms control the movement action of socket holding locking balls.

FIG. 2 Is a parallel projection cross sectional view of the working upper end of the push button release multiple socket holders internal mechanisms and how they intersect with each other.

FIG. 3 Is a parallel projection cross sectional view of the internal mechanisms and how they intersect with each other.

FIG. 4 Is an isometric view of the push button release multiple socket holders bottom backing plate, the recessed opening in the body of the socket holders top, where the main release control rods top section which is the push button is to be activated from in the socket holders main body

FIG. 5 Is a parallel projection of the back side of the push button release multiple socket holders body without the backing plate on it, showing main push rod slot, main body control rod lock key notch, guide holes for push rods, and recessed push button opening.

FIG. 6 Is an isometric cross sectional view of the push button release multiple socket holders body, this shows where the control rod locking key goes in the main body control rod lock key notch, along with other internal working intersecting parts.

FIG. 7 Is a parallel view of the push button release multiple socket holders body part called the main release control rod and the main spring, it shows the push button top of the main release control rod, the control rod lock notch, and the main release main release control rod intersect notches along with the main spring.

FIG. 8 Is an isometric view of the right side of the “PUSH BUTTON RELEASE MULTIPLE SOCKET HOLDER” with the push button protruding out of the main socket holder body in an enlarged way for viewing purposes in the drawing. Also the SAE size markings on it also

[symbol]

FIG. 9 Is an isometric view of the left side of the “PUSH BUTTON RELEASE MULTIPLE SOCKET HOLDER” with the push button protruding out of the main socket holder body in an enlarged way for viewing purposes in the drawing see it. Also the METRIC size markings on it also

[symbol]

### PARTS LIST

1. MAIN SOCKET HOLDER BODY
2. MAIN PUSH ROD SLOT
3. PUSH BUTTON
4. MAIN RELEASE CONTROL ROD
5. MAIN SPRING
6. MAIN SPRING HOLDER POSITION
7. SOCKET LOCKING BALLS
8. SOCKET LOCKING BALL HOLES
9. INTERNAL LOCKING BALLS
10. PUSH RODS
11. INDIVIDUAL SOCKET HOLDER PUSH SPRINGS
12. BACKING PLATE
13. CONTROL ROD LOCK KEY
14. CONTROL ROD LOCK NOTCH
15. MAIN BODY CONTROL ROD LOCK KEY NOTCH
16. GUIDE HOLES FOR PUSH RODS
17. SLIDING PUSH BUTTON LOCK PLATE
18. RECESSED PUSH BUTTON OPENING
19. HANDLE
20. INDIVIDUAL SOCKET HOLDER MOUNTINGS
21. PUSH BUTTON COVER SHIELD
22. STAMPED SIZES OF SOCKET HOLDER SPACES SAE AND METRIC OR AS DESIRED
24. MAIN RELEASE CONTROL ROD INTERSECT NOTCHES

### DETAILED DESCRIPTION OF THE INVENTION

The invention being discussed here is a tool socket holder which has a built in user controlled internal locking mechanism. This locking mechanism allows users of this multiple socket holder to place sockets securely onto the socket holder where they are to be held until they are released by the internal locking mechanism's by the pressing of this socket holders push button release control mechanism.

This locking multiple socket holder has been given a name and it is herein called a “PUSH BUTTON RELEASE MULTIPLE SOCKET HOLDER” and by means of built in mechanical locking control mechanism's it performs the task of holding and releasing sockets from its main body. The internal locking mechanism's are controlled by the pressing down of a push button which protrudes out of its main body into a recessed opening. The exposed push button which goes into the recessed opening on the main socket holders body also goes down through the socket holders main body where it intersects other internal parts where it creates the holding and releasing action for the sockets to be mounted onto the socket holders main body.

This device is designed to hold or release sockets held onto its main body quickly and easily and securely only to be released when desired by the user through use of its push button.

The kind of sockets being discussed here are of the kind and type that are commonly used by mechanics and construction workers on their ratchet wrench's, breaker bars, impact wrench guns etc, or any type of fastener driver head that is mounted onto a socket and is to become part of a socket driven system.

The “PUSH BUTTON RELEASE MULTIPLE SOCKET HOLDER” has a main body, a multiple of individual socket holder spaces on it, with each socket holder space on the main socket holder body having its own built in individual secure socket holding locking ball release mechanism.

These built in secure socket holding locking ball release mechanisms are all in the socket holding lock positions when the main push button is not being pushed down. To release sockets from the locking ball mechanism's of the socket holder the user has to press down on the push button. When the user is ready to lock the sockets back onto the socket holder all they have to do is let go of the push button, because internal spring mechanism's lift the push button and push all moving parts back to the position of locking sockets on mode.

As many individual socket holder spaces as desired can be built into the main socket holders main body, along with having different size drive socket spaces, all using the basic design shown here in this disclosure.

On the back side of the socket holders main body there is an opening called the main body lock notch which holds a special lock key in its place, this lock key serves the purpose of allowing the push button main release control rod to go up and down in the main body of the socket holder intersecting with the internal parts that control the locking mechanism's while also keeping the push button from coming out of the socket holders main body when not being pushed down by the user. This key intersects with a cutout space on the main release control rod which goes up and down in the main body in the main push rod slot. At the end of this main release control rod is the push button of the socket holder which protrudes into a recessed opening of the socket holder.

The back plate is mounted on the back of the main body of the socket holder into its designated cut out space. This back plate can have a magnetic back on it if desired and serves the purpose of keeping dirt and debris out of the socket holders main body internal parts section. After all the internal parts are installed and the back plate is mounted the only external moving parts on the “PUSH BUTTON RELEASE MULTIPLE SOCKET HOLDER” are the push button in the recessed opening, and the locking balls on each of the designated socket holding places on the main socket holder.

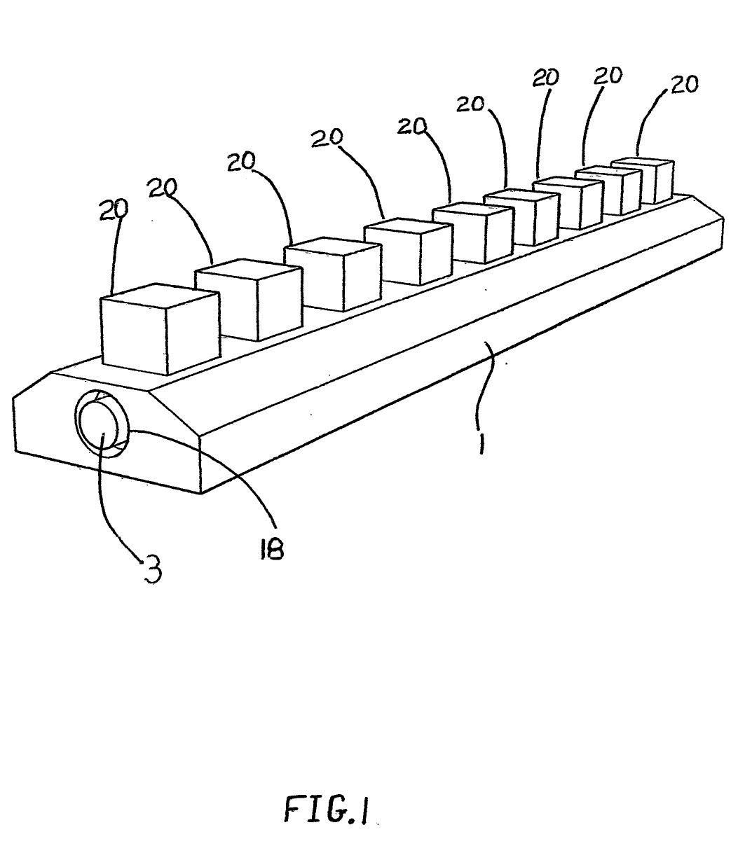

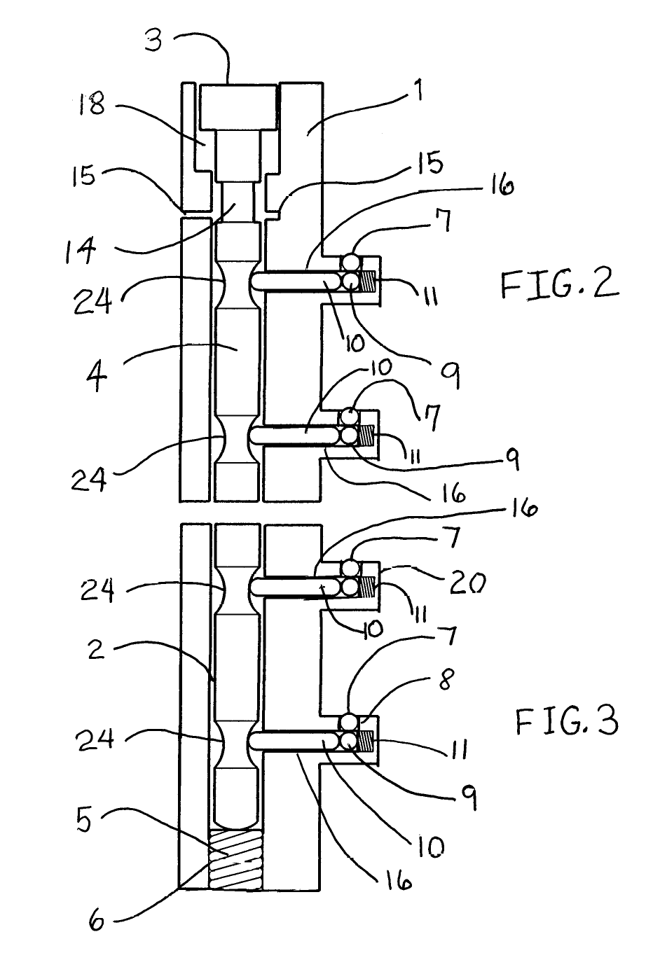

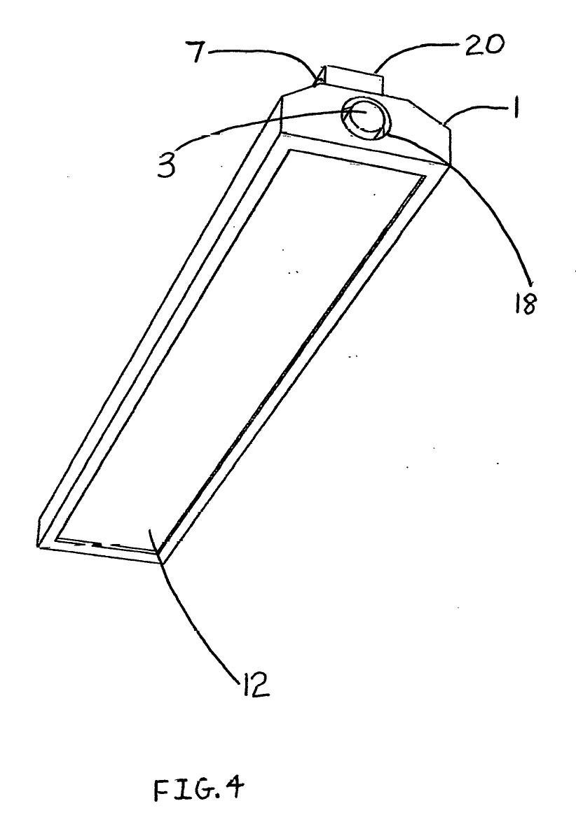

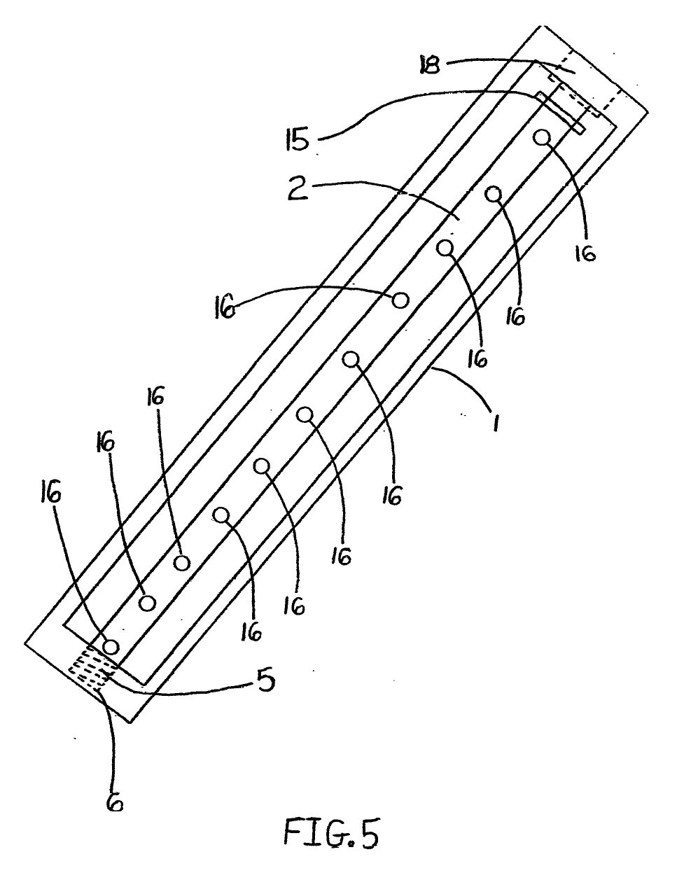

Other features that can be made into the “PUSH BUTTON RELEASE MULTIPLE SOCKET HOLDER” that an not shown in the drawings but are being described here are as listed below.
1. as an alternative embodiment to internal locking balls 9 as shown in FIG. 2. and FIG. 3. the internal locking balls 9 could be replaced by a push rod 10 that has been modified by being a little longer and having a small rounded notch resembling main release control rod intersect notches 24 the placement of a small notch in it that would allow the socket locking ball 7 to go down in the socket locking ball holes 8 when push button 3 is pressed down allowing for the sockets locking balls 7 holding and release mechanisms to operate and function as described with the preferred embodiment shown in the drawings from the individual socket holder mountings 20 socket locking ball holes 8 which would allow for in and out movement of the socket locking balls 7 this alternative modification could be used to replace the internal locking ball 9 and leave a push rod 10 that is a little longer with a slight notch in it resembling the main release control rod intersect notches of 24 but only in a smaller size so the push rods 10 would go into guide holes for push rods 16.
2. also as shown in FIG. 4 area of the drawings a small sliding cover plate could be mounted onto the top of the socket holders main body 1 push button 3 and recessed push button opening 18 hole, this would add to preventing accidental pushes of the release push button 3 and also help to keep this recessed push button opening 18 hole dean from foreign matter and debris.
3. also as shown in FIG. 4 area of the drawings on main socket holder body 1 at both sides of push button 3 and recessed push button opening 18 could be handle mounting holes which have an internal notch allowing for a push button plug device to go into them and have a handle attached to it, it would resemble the push button type of connector that is on a locking key holder. With a push of each handles button connector each side of the handle could go down into a hole mounted on each side of the recessed push button opening 18. Also these connector holes in the main socket holder body could be connected together for carrying multiple main socket holder body's 1 as desired. The use of push button connection with an internal ball and connection hole with an internal connection ring notch would allow for the handles to he removed if not needed or desired.
4. also in FIG. 4 area of the drawings on the main socket holder body 1 where the backing plate 12 is could be a magnet mounted if desired for holding the “PUSH BUTTON RELEASE MULTIPLE SOCKET HOLDER” to a metal surface.
5. also in FIG. 1 area of the drawings the main socket holder body 1 could also be made to be a multiple Multiple “PUSH BUTTON RELEASE MULTIPLE SOCKET HOLDER” with many main socket holder body's 1 built into one main unit.
6. also in FIG. 1 area of the drawings the individual socket holder mountings 20 could be of different drive sizes on the same main socket holder body 1 to accommodate different size drive sockets as needed.
7. also in FIG. 1 area of the drawings the main socket holder body 1 could have on one side of the individual socket holder mountings 20 SAE sizes with a number place also on it and on the other side of the individual socket holder mountings 20 METRIC sizes markings with a numbered place also for the places sockets of a set go and when not in set order number order for the user as needed numbered in numerical order for users who just prefer a numbered space to a socket size space to have SAE metric and numerical numbers on the sides of the individual socket holder mountings 20.
8. also in FIG. 1 area of the drawings individual socket holder mountings 20 could have their own push button release mechanisms but the preferred embodiment is the way the drawings in this application have described, being more efficient and also less parts but just mentioned it could be possible to have individual release mechanism's similar but smaller than the preferred embodiment as shown and described in this disclosure.
9. an additional safety lock for preventing accidental release of sockets could be mounted into as shown in main socket holder body FIG. 1 1 body which would engage control lock notch FIG. 2. 14 this would be a safety lock pin that would be pushed from one side of the main socket holder body FIG. 1 1 thru to intersect with the cut out control lock notch FIG. 2. 14 on the main release control rod 4 this would create a locking action of the up and down movement of the push button 3 which is also the end of main release control rod 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a socket holder for a multiple of sockets which has a built into it socket holding locking mechanism, which holds and releases multiples of sockets being held onto it with the push of a button that controls locking mechanisms to hold and release sockets from the main socket holders body when desired by the user.

The push button release multiple socket holder being described here in detail has as shown in FIG. 1 a main body 1, and any number of desired individual socket holder space positions 20 placed along its main body 1 it has a recessed push button opening on it 18

[symbol]

Referring to FIG. 4 as shown it has a push button 3 protruding thru the main socket holder body 1

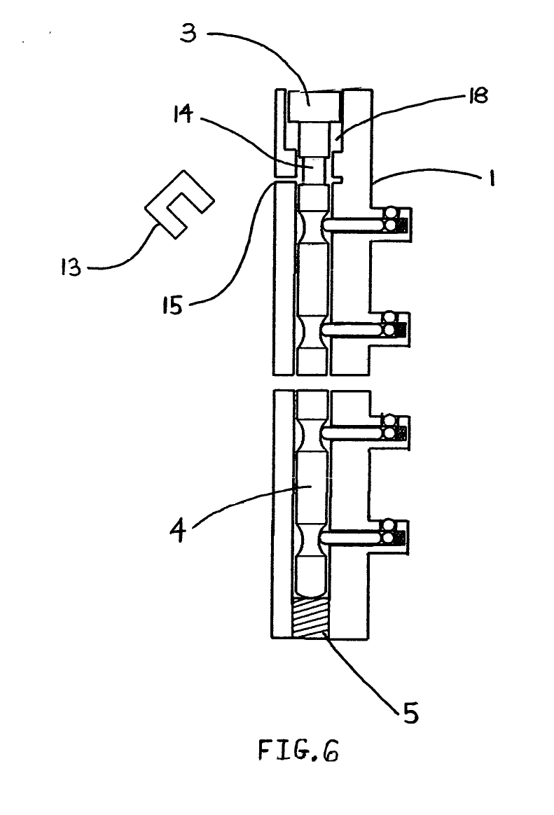

Referring to FIG. 6 as shown the push button 3 is made on the end of the main release control rod 4 which goes thru the main socket holders body 1, where the bottom end of the main release control rod 4 contacts the main spring 5 is placed in the main body 1 in the

[symbol]

Referring to FIG. 3 main spring holder position 6. which pushes the main release control rod 4 back up after the

[symbol]

Referring to FIG. 2 push button 3 has been pushed down into the recessed push button opening 18 where the control rod lock key 13 is placed into the main body 1 in the main body control rod lock key notch 15 which is made to intersect the

[symbol]

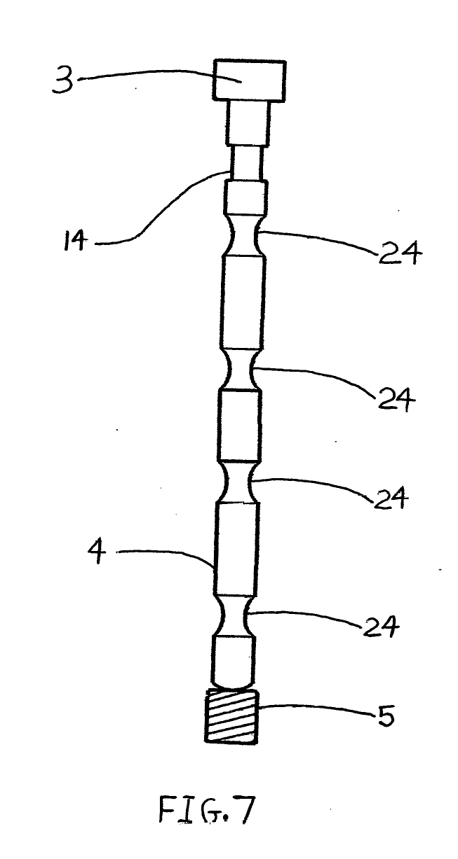

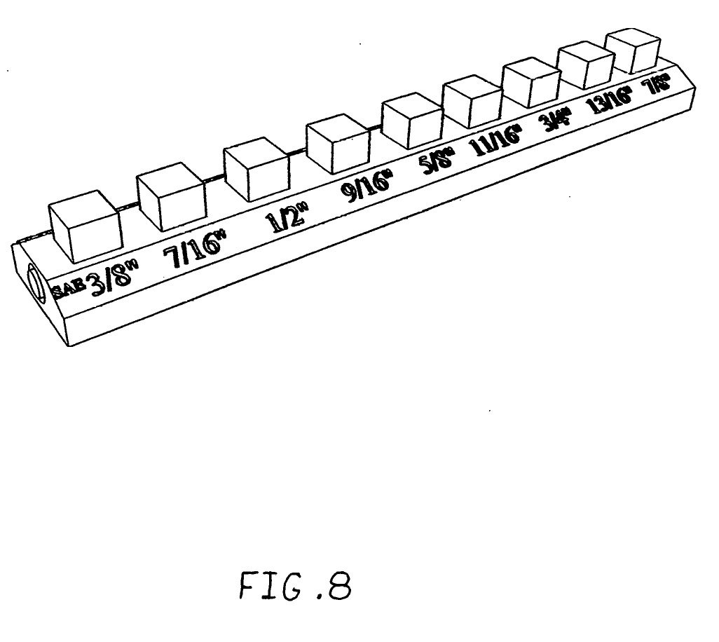

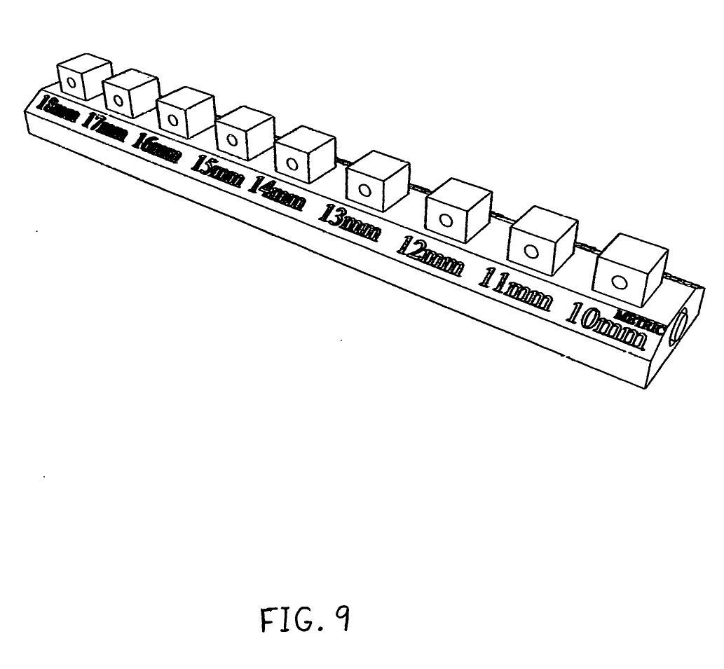

Referring to FIG. 7 main release control rod lock notch 14 which holds the main release control 4 in place in the

[symbol]

Referring to FIG. 6 main socket holder body 1 as the main release control rod 4 goes up and down in

[symbol]

Referring to FIG. 2 and FIG. 3 main push rod slot 2 where the main release control rod 4 intersect with the push rods 10 at the main release control rod 4 main release control rod intersect notches 24 which then pushes push rods 10 against internal locking balls 9 which presses against individual socket holders push springs 11 which are all placed in the guide holes for push rods 16 which allows for the socket locking balls 7 to go in or out in the socket locking ball holes 8 where the socket locking ball holes 8 have all been crimp pressed after the socket locking balls 7 were placed in them upon making of the device to hold the socket locking balls 7 from coming out of their socket locking ball holes 8 in the individual socket holder mountings 20. When push button 3 is released from being pressed down the main spring 5 pushes the main release control rod 4 back up to where the control rod lock notch 14 meets the

[symbol]

Referring to FIG. 6 control rod lock key 13 which stops the upward movement of the main release control rod 4 in the proper place to align all of the internal parts to go back into the socket holding lock positions as this happens

[symbol]

Referring to FIG. 2 and FIG. 3 the push rods 10 internal locking balls 9 and socket locking balls 7 all go back into the socket holding lock positions because the individual socket holder push springs 11 push these parts back into their original socket holding locked positions as these guide holes for the push rods 16 which allows for the internal locking balls 9 on the individual socket holder mountings 20 lift the socket locking balls 7 back up to the out and locking positions

[symbol]

Referring to FIG. 2. and FIG. 3. when the main release control rod 4 is pushed down by use of its top end push button 3 the internal push rods 10 in the guide holes for push rods 16 press against and move the internal locking balls 9 against the individual socket holder push springs 11 which allows the socket locking balls 7 to go into the individual socket holder mounting 20 socket locking ball holes 8 which allows sockets to be placed on or off of the individual socket holder mounting 20, and when the push button 3 is released from being pushed down the push rods 16 and the internal locking balls 9 and the socket locking balls 7 the socket holder push springs 11 all go back to their original positions by the force of the socket holder push springs 11 and the main spring 5 placed at the bottom end of the main push rod slot 2 which is located in the main spring holders position 6.

Referring to FIG. 4 when all of the internal parts are assembled and in place the backing plate 12 is put on the back of the main body 1 making the only external moving parts the push button 3 and the

[symbol]

Referring to FIG. 2 and FIG. 3 socket holding socket locking balls 7.

The invention claimed is:

1. A socket holder which has a user controlled socket locking hold and release mechanism the device is made out of steel aluminum or any hard resin plastics or any other suitable hard material and it has a locking hold and release mechanism in each socket holding space on it main body where sockets mounted to its main socket holding body are held or released by a locking control release mechanism.

2. A lockable socket holder comprising of at least one lockable socket holder body space or many multiples of lockable socket holder body spaces mounted onto a main socket holders body with all of the holder spaces having its own socket locking holder mechanism which is controlled by the user and has a control mechanism built into the main socket holders body where it interacts with all of the socket holder body's spaces on the main socket holder's body where the locking mechanisms of each socket holder body are controlled with a mechanical device or a push button which control's all of the internal hold and release locking mechanism's that control each socket holder body space locking mechanism's allowing sockets to be placed on and off of the locking socket holders main body by means of the locking hold mechanism's.

3. A locking socket holder which comprises: of a main body, with at least one or a multiple of socket holding storage spaces on the main socket holders body with each socket holding storage space on the main socket holder body having a socket holding locking device mechanism made into it and these locking socket holder spaces have a user controlled socket locking hold or release mechanism that is built into the main socket holders body that allows for held sockets on individual socket holding spaces to be removed or placed on the main socket holders body by its internal locking hold or release mechanism's which allow for one or a multiple of various sized drive and size sockets to be placed on or off of the main socket holder's body while securely holding any sockets which have been placed onto this holder to be held securely to be released when the user engages the main socket holder body's built in holding and release control mechanism which controls the holding or releasing of the sockets which have been placed on it or the placement of more sockets on the main socket holders body by activating the control mechanism which controls the socket holders internal locking mechanism's.
